(19) United States
(12) Patent Application Publication
(10) Pub. No.: US 2025/0035379 A1
(43) Pub. Date: Jan. 30, 2025

(54) Methods and Systems for Constructing a Hydrocarbon Processing Facility

(71) Applicant: ExxonMobil Chemical Patents Inc., Baytown, TX (US)

(72) Inventors: Thomas T. Hirst, Houston, TX (US); David Spicer, Houston, TX (US); Tim W. Hopkins, Battery Point (AU); Samuel L. Almeida, Spring, TX (US); Mark A. Rooney, Pasadena, TX (US)

(21) Appl. No.: 18/716,829

(22) PCT Filed: Jan. 17, 2023
(86) PCT No.: PCT/US2023/060748

§ 371 Date: Jun. 5, 2024

Related U.S. Application Data
(60) Provisional application No. 63/307,430, filed on Feb. 7, 2022.

(51) Int. Cl. F27D 1/00; B01D 53/86

(52) U.S. Cl. CPC F27D 1/00; B01D 53/8631; B01D 2251/2062; B01D 2257/404; B01D 2258/0283; F27D 2001/0079

(57) ABSTRACT

The present disclosure relates to methods of constructing a furnace facility including determining transport parameters including vessel parameters. The method can include determining operating site parameters of an operating site and designing one or more modules based on the vessel and operating site parameters. The modules can be sized to provide length, width, height, weight of the modules within allowance of the vessel and operating site parameters. The modules can be constructed at a module fabrication site before transporting to the operating site via a vessel. One or more modules can have one or more furnace components, and/or one or more modules can have one or more furnace.

### CROSS-REFERENCE TO RELATED APPLICATION

This application claims priority to and the benefit of U.S. Provisional Application No. 63/307,430 having a filing date of Feb. 7, 2022, the disclosure of which is incorporated herein by reference in its entirety.

### FIELD

The present disclosure generally relates to methods and systems for constructing a hydrocarbon processing facility. The methods and systems are particularly useful for, e.g., constructing steam cracking furnaces in an olefins production plant.

### BACKGROUND

Steam cracking, referred to as pyrolysis, is used to crack various hydrocarbon feedstocks into olefins, such as ethylene, propylene, and butenes. Conventional steam cracking uses a pyrolysis furnace (“steam cracker” or “steam cracking furnace”) which has two main sections: a convection section and a radiant section. The hydrocarbon feedstock can enter the convection section of the furnace as a liquid. The feedstock can be heated and vaporized by indirect heat exchange with hot flue gas from the radiant section and by direct contact with steam. The vaporized feedstock and steam mixture is then introduced into the radiant section where cracking of the hydrocarbon feedstock takes place. The effluent exiting the radiant section is typically quenched and separated to recover various products such as ethylene, propylene, and the like. As hydrocarbon processing capacity expands, large industrial projects are undertaken to engineer, procure, and construct new hydrocarbon processing facilities, such as ethylene plants which often include steam cracking furnaces. Increased availability of low cost hydrocarbons, such as natural gas and ethane, has incentivized the construction of processing facilities. The capital return on investment can be based on time involved to construct a facility, operating cost of the facility, cost of products produced, and the capital cost invested in engineering and construction of the facility.

Traditionally, steam cracking furnaces are constructed by using stick-building in the operating site of the furnaces, where numerous small individual components such as pipes, instruments, steel plates, nuts and bolts, and the like, are assembled into the furnaces. In certain situations, small portions of a steam cracking furnaces may be pre-fabricated at a place different from the operating site, and then shipped to the operating site, where they are assembled into the furnaces together with still a large number of other components. Such construction strategies requiring significant assembling and installation at the operating site can be subjected to constraints such as limited operable space, unfavorable working conditions and government regulations, require prolonged assembling/construction time, and therefore often are logistically and/or financially prohibitive. Pre-fabricating a large module comprising a large portion of a single furnace, let alone a full furnace, off the operating site, and then transporting the large module to the operating site for installation has faced challenges such as the high upfront module fabrication costs and complexities in designing, engineering, fabricating, transporting, and eventual installing the large modules.

There is a need for methods and systems for constructing a steam cracking facility in a cost-effective manner. This disclosure satisfies this and other needs.

### SUMMARY

In at least one aspect, a method of constructing a furnace facility including one or more furnaces is provided including determining transport parameters such as vessel parameters. The method can include determining operating site parameters of an operating site. The method can further include designing one or more furnace modules based on the transport parameters and operating site parameters. The modules can be sized to provide length, width, height, and/or weight of the modules within allowance of the transport parameters and the operating site parameters. The modules can be constructed at a module fabrication site. Each of the furnace modules can have one or more furnace components. The furnace modules can be transported via the vessel. The furnace can be advantageously a steam cracking furnace. The furnace facility can include a cluster of multiple steam cracking furnaces. The operating site can be an olefins production plant including one or more steam cracking furnaces.

In another aspect, a furnace module is provided including at least two furnaces. Each furnace has a radiant section and a convection section. The furnace module can include a module interconnection disposed between each furnace.

In still another aspect, a furnace assembly is provided including an upper furnace module corresponding to an upper portion of the convection section; and a lower furnace module corresponding to a lower portion of the convection section and the radiant section of the furnace assembly.

In yet another aspect, a method is provided for constructing a furnace facility. The method includes evaluating a value for modularization based on location, existing infrastructure, and transport channels of an operating site. The method includes determining size, weight, and center of gravity parameters of a transport vessel and the furnace facility and designing one or more modules based on the size, weight and center of gravity parameters of the transport vessel and the furnace facility. The one or more modules are sized to maximize the size, weight, and center of gravity parameters of the transport vessel and/or the furnace facility. The method includes constructing the one or more modules at a module fabrication site, at least one of the modules comprising at least auxiliary equipment. The auxiliary equipment can include an electrical room and an analyzer shelter. The method includes testing the auxiliary equipment at the module fabrication site and transporting the module via the transport vessel.

Further areas of applicability will become apparent from the description provided herein. The description and specific examples in this summary are intended for purposes of to illustration only and are not intended to limit the scope of the present disclosure.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 depicts a schematic front-view of a furnace module having two furnaces in accordance with an embodiment.

FIG. 2 depicts a schematic view of a furnace assembly having two modules in accordance with an embodiment.

FIG. 3 depicts module installation at an operating site in accordance with an embodiment.

FIG. 4 depicts a flow diagram of a method for constructing a hydrocarbon processing facility in accordance with an embodiment.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION

The present disclosure provides methods and systems for constructing a furnace facility including one or more furnaces. In preferred embodiments the furnace is a steam cracking furnace for pyrolyzing hydrocarbons, and the furnace facility is a steam cracking facility. Other furnaces and furnace facilities are also contemplated in this disclosure, particularly industrial furnaces having a large size and the construction, transportation, and/or installation of which are subjected to various constraints, e.g., limited space availability, physical obstacles, and the like. The method can include determining operating site parameters of an operating site and designing one or more modules based on the transport parameters and operating site parameters. The modules can be sized to provide length, width, height, and/or weight of the modules within allowance of the transport parameters and operating site parameters. The modules can be constructed at a module fabrication site separate from the operating site. The modules can have one or more furnace components, and the modules can be transported from the module fabrication site and can be installed at the operating site.

As used herein, the term “furnace module” or “module” refers to a transportable structure comprising multiple components of one or more furnaces. A furnace module, if prefabricated, may be transported to an operating site and installed at the operating site to construct the furnace facility. Preferably the installation of the furnace module at the operating site does not significantly alter the existing components contained therein. A furnace module can correspond to, e.g., (i) a portion of one furnace, (ii) a combination of a portion of one furnace and certain auxiliary equipment, (iii) the entirety of one furnace, (iv) a combination of the entirety of one furnace and certain auxiliary equipment, (v) more than one furnaces (e.g., two furnaces joined together, three furnaces joined together), or (vi) a combination of more than one furnaces and certain auxiliary equipment.

Each furnace in the furnace facility comprises a plurality of furnace components. At least one, in certain embodiments 2, in certain embodiments 3, in certain embodiments all, of the furnace modules in one or more embodiments of the methods of this disclosure can comprise, e.g., 25%, 30%, 35%, 40%, 45%, 50%, to 55%, 60%, 65%, 70%, 75%, to 80%, 85%, 90%, 95%, or even 100% of the plurality of components in a designated furnace among the one or more furnaces. For large-scale furnaces, such as steam cracking furnaces, the furnace modules of this disclosure can be very large in size and weight, significantly larger than furnace modules fabricated and utilized in the prior art. The design, construction, transportation, and installation of such large modules can be very costly, complex and challenging.

In certain preferred embodiments, the designated furnace can comprise a convection section and a radiant section, and a furnace module can comprise an upper module section positioned above and abutting a lower module section, where the upper module section corresponds to an upper portion of the convection section, and the lower module section corresponds to a lower portion of the convection section and the radiant section. In such embodiments, the furnace module can be constructed by: (i) constructing the upper module section and the lower module section separately; (ii) positioning the upper module section above and abutting the lower module section; and (iii) mechanically securing the upper module section to the lower module section to construct the furnace module. Preferably, in these embodiments, the upper module section comprises one or more first vertical reinforcement member (e.g., steel beams), the lower module section comprises one or more second vertical reinforcement member; and the first vertical reinforcement member and the second reinforcement member are connected to form a unitary reinforcement component in the furnace module.

In certain other preferred embodiments, the designated furnace can comprise a convection section and a radiant section, and the one or more furnace modules can include an upper furnace module and a lower furnace module, where the upper furnace module corresponds to an upper portion of the convection section, and the lower furnace module corresponds to a lower portion of the convection section and the radiant section. In such embodiments, the upper furnace module and the lower furnace module, separate from each other, can be transported to the operating site; and at the operating site, the upper furnace module can be positioned over and abutting the lower furnace module in constructing the designated furnace. Where desired, additional connection between the upper furnace module and the lower furnace module can be made at the operating site to complete the installation of the designated furnace. These embodiments are particularly advantageous where the transport parameters and/or the operating site parameters comprise a constraint preventing transporting an alternative, taller module comprising the upper furnace module positioned over and abutting the lower furnace module, e.g., where the transportation of the modules involves passing under a bridge or an existing pipeline with limited overhead clearance insufficient for the safe passage of the tall, alternative module.

In certain other preferred embodiments, the furnace facility comprises multiple furnaces, wherein at least two adjacent steam cracking furnaces present in the furnace facility are connected to form a multiple-furnace cluster comprising a plurality of cluster components. In these embodiments, preferably the furnace module comprises from, e.g., 60%, 65%, 70%, 75%, 80%, to 85%, 90%, 95%, or 100% of the plurality of cluster components in the multiple-furnace cluster. For large industrial furnaces such as the steam cracking furnaces, such furnace module for furnace clusters are very large in size and weight, making designing, engineering, fabricating, transporting, and installing them particularly costly, complex, and challenging.

In certain preferred embodiments, the furnace module comprises a plurality of structural reinforcement components that maintain structural integrity of the furnace module during fabrication, transportation, and installation thereof. The structural reinforcement components may comprise a plurality of vertical beams and a plurality of horizontal beams, which, together with the components contained in the module, provide the needed sturdiness and rigidity to withstand the stress and shock the module may experience when moved, lifted, or positioned.

In certain embodiments, the furnace module may comprise, in addition to the furnace components, auxiliary equipment connected directly or indirectly to the furnace components. Examples of auxiliary equipment include, but are not limited to: a local electrical room; a local analyzer shelters, an ammonia vaporization facility for a selective catalytic reduction (“SCR”) unit; a decoke drum; and control valve deck and associated platform.

In certain embodiments, to facilitate ground transportation of the furnace module, e.g., from the module fabrication site to the loading dock, loading the module onto a vessel, unloading the module from the vessel, and ground transportation of the vessel from the unloading dock to the operating site, and/or the eventual installation, the furnace module may preferably have a base section capable of coupling to one or more self-propelled modular transporter (“SPMT”).

Because of the size and complexity of a large furnace module, its fabrication cost can be very high, and the ensuing loss can be very high as well if it is damaged during transportation and installation. As the module becomes larger, the perceived risk of sustaining damage during transportation and installation becomes higher. Because of the perceived risk of damage increases with the shipping distance, historically it has been preferred that even relatively small modules are produced at fabrication sites within a short distance from the operating site.

We have found that by determining the transport parameters and operating site parameters, the furnace modules can be designed accordingly with the desired features such as dimensions, weight, structural robustness, and transportation and installation can be carefully planned accordingly, resulting in mitigated risk of damage during transportation and installation, even if a long transportation distance exists between the fabrication site and the operating site, or multiple space constraints exist on the transportation route or at the operating site.

Thus, in the methods of this disclosure, fabrication of the module is preferably conducted at a module fabrication site separate from the operating site, especially in cases where the operating site is an existing production site with limited space availability and/or having multiple site constraints. The module fabrication site may be sometimes called a “module yard.” In certain preferred embodiments, the module fabrication site has sufficient work space allowing the simultaneous fabrication of multiple parts of a module and/or multiple modules by multiple workers or multiple teams of workers, thereby permitting fast and efficient fabrication of an individual module and multiple modules. A modem olefins production plant can include, e.g., 4, 5, 6, 7, 8, 9, 10, 11, 12, or even more large and complex steam crackers. The choice of such spacious module fabrication site enabling parallel fabrication can significantly shorten the overall time required for completing the fabrication of all modules. In certain preferred embodiments, the module fabrication site can be located in an area with desirable labor costs to reduce the overall costs of the fabrication. In certain preferred embodiments, the module fabrication site can be located in an area with sufficient supply of skilled labor capable of completing the fabrication work with consistently high quality. In certain preferred embodiments, the module fabrication site is in close proximity to a port where a completed module can be conveniently loaded onto a water-bome vessel with minimal ground transportation required from the fabrication site to the loading dock, thereby reducing the risk of damage to the modules caused by vibration associated with ground transportation. The choice of the module fabrication site can significantly affect the labor costs, fabrication timeline, and quality of the fabricated module. In various embodiments of the methods of this disclosure, transport parameters are determined and considered in designing the module.

A category of transport parameters that may be determined and considered is vessel parameters, if the module transportation includes the use of a water-bome vessel. Vessels transportation can be particularly advantageous for transporting large modules over long distances, e.g., from a fabrication site in one continent to the operating site in another. Ground transportation of large modules over long distances may be infeasible due to physical constraints imposed by the rails or roads. Examples of vessel parameters include a width allowance, a length allowance, a height allowance, and a weight allowance of the vessels available for transportation. Based on these parameters, the furnace modules can be designed to have a module width, a module length, a module height, and a module weight. One may design the modules such that the vessel of choice may accommodate one, two, three, four, or greater number of modules per load. Thus, for example, in certain embodiments, one may design a furnace module such that the module length is from about 25% to 100% of the length allowance, the module width is about 25% to 100% of the width allowance, the module height is about 25% to 100% of the height allowance, and the module weight is about 25% to 100% of the weight allowance.

Other transport parameters that may be determined and considered include, but are not limited to: vessel dock length, vessel dock width, vessel dock shape, height of obstruction(s) during transport, economics in procuring vessels, vessel draft when loaded, depth along path during transport, and any combinations thereof. Optimal choice of module dimensions, module weight, module weight, module fabrication site choice, vessel choice, and number of modules per vessel load, and transportation route to the loading dock can be made to reach a combination of high level of economy, low risk of damage to the modules, and low risk of damage to the environment along the transportation route to the loading dock and during the loading operation, leading to an overall high economy and low risk profile of the project.

Examples of operating site parameters that may be determined and considered include, but are not limited to: maximum weight restriction of a road leading to the operating site, soil condition of a road leading to the operating site, height of an obstruction along a road leading to the operating site, width of an obstruction along a road leading to the operating site, a road turn radius restriction, an equipment lift, workforce location at the operating site, land transport ability, and any combination thereof. Such parameters can inform the ground transportation of the furnace modules from an unloading port to the operating site, and the eventual installation of them at the operating site. Measures can be planned and taken to reduce costs, risks of damage to the modules, risks of damage to the environment along the transportation route, and risks of damage to existing equipment at the operating site, leading to an overall high economy and low risk profile of the project.

It has been discovered that certain operating sites have productivity or workforce limitations. Modularization can provide modules to be assembled at a location with adequate labor and productivity. Module fabrication sites can produce large modules having sufficient infrastructure, staffing, and productivity rates to provide cost and quality higher than installing furnaces at an operating site. Additionally, selected operating sites can require preparation prior to furnace assembly, such as reclaimed land, permitting, and the like. Modularization provides construction of the module prior to or parallel with the preparation of the operating site. Significant time and cost savings can be provided.

Thus, we have found that, surprisingly, by determining and considering the transport parameters and operating site parameters, we are able to design furnace modules with large dimensions and/or weight, fabricate them at a module fabrication site with desirable efficiency and quality, transport them to the operating site (even over longer distance, e.g., over 1,000 kilometers), and install them at the operating site, notwithstanding the many constraints that may exist in every step, with a desirably high level of project economy, a desirably short project completion time, and a desirably low risk profile, defying the previous suspicion of such endeavor as described above.

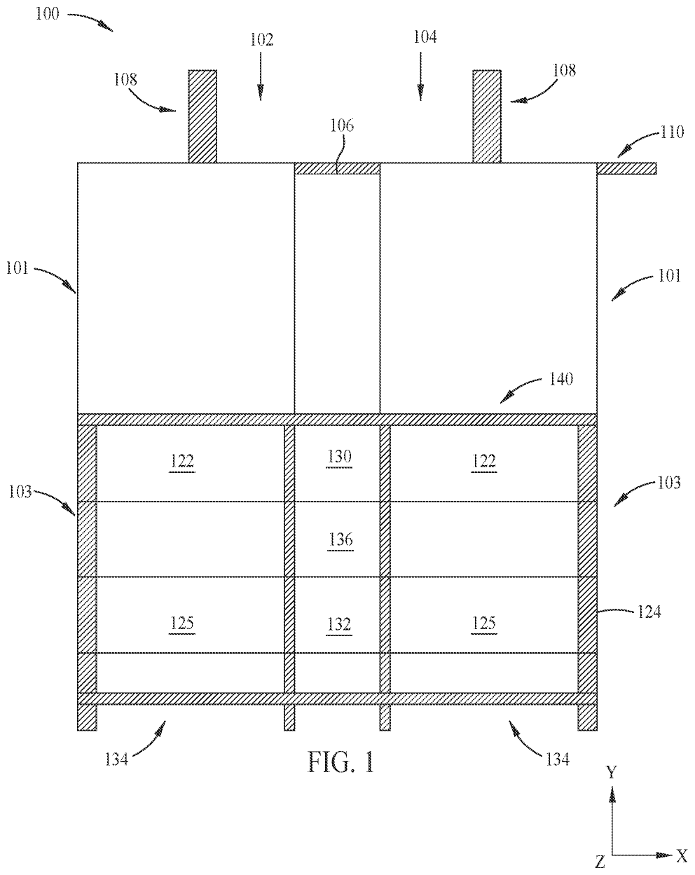

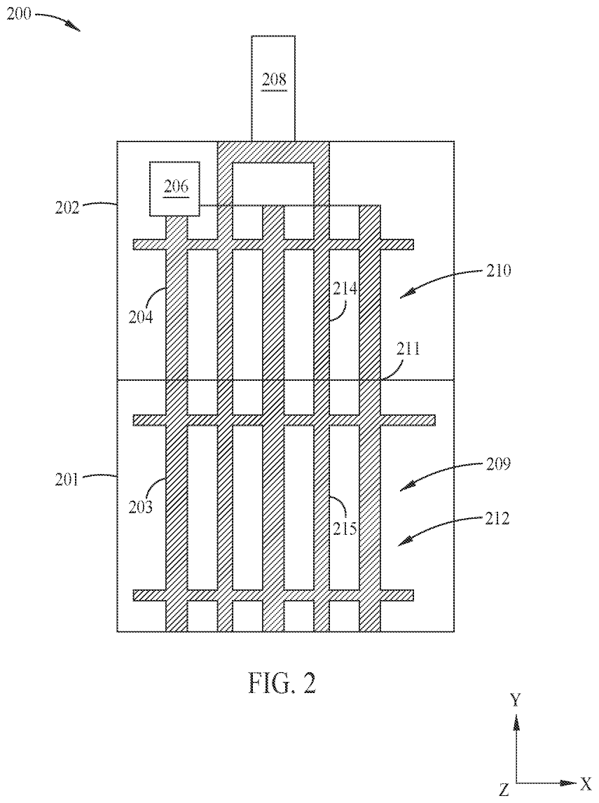

FIG. 1 and FIG. 2 depict non-limiting different module embodiments according to various embodiments. FIG. 1 provides a single module with two furnaces with optional auxiliary equipment incorporated therein, preferably to be installed at a new operating site. FIG. 2 provides multiple modules including different portions of a single furnace, preferably to be installed at an existing operating site which may have various transportation/installation constraints. Although some module embodiments are described and shown herein, other embodiments are also contemplated.

Single Module with Two Furnaces

FIG. 1 depicts a schematic front-view of a furnace module having two furnaces in accordance with one embodiment. The furnace module 100 includes a first furnace 102 and a second furnace 104. Each furnace includes a radiant section 103 and a convection section 101. Each furnace can include a furnace stack 108. The first and second furnaces can be coupled by a module interconnect 106. The module interconnect 106 can include a cross bracing, a platform, interconnecting steel, or any combination thereof.

Each module can be accessible from one module to another using connecting platforms 110. Additional modules can be coupled to the furnace module 100. The furnace module 100 can include a plurality of sections, the one or more sections are disposed on one or more levels of the furnace module 100. The sections can include at least one control valve deck 140 having a block valve, a control valve, and one or more pipes (not shown). The furnace module 100 can include decoke drums 122 and decoke to firebox piping (not shown).

The furnace module 100 can further include auxiliary equipment, such as an electrical room 132, an analyzer 136 for analyzing a process stream, or combinations thereof. The auxiliary equipment can be common auxiliary equipment for the two furnaces. In some embodiments, the auxiliary equipment can include a common analyzer enclosure for analyzers. The analyzers may be used to analyze compositions of one or more process streams or products. The electrical room 132 may be a “local” electrical room disposed between each control valve deck 125 for each furnace and configured to power each furnace 102, 104 disposed on the furnace module 100. It has been found that integrating auxiliary equipment to the module enables ease of integrating the assembly at the operating sites. In conventional operating sites, auxiliary equipment is located away from the furnaces and requires connections that are made at the operating site. The integrated auxiliary modules described herein provide a system that can be connected easily at the operating site with reduced time at the operating site. In some aspects, auxiliary lines for one or more modules can be installed at the module fabrication site and tested at the module fabrication site prior to installing the module at the operating site. Installing auxiliary lines includes installing electrical and instrument lines for two or more furnaces in one or more modules, installing electrical and instrumentation lines for the auxiliary equipment in one or more modules, installing electrical lines to the local electrical room, and/or installing sample tubing in one or more modules. The furnace module 100 includes an ammonia vaporization skid 130 configured for selective catalytic reduction unit (SCR), e.g., at an uppermost location on the control valve deck 140.

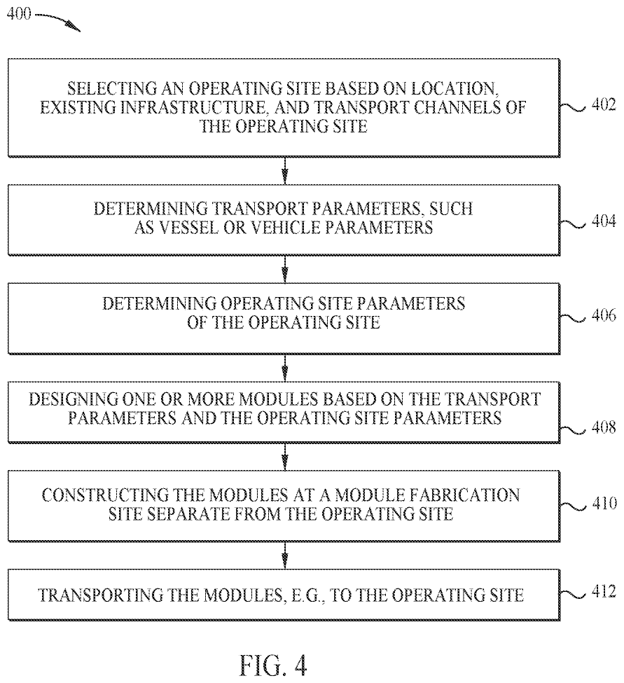

The furnace module can includes a base section 134 configured for transport using one or more self-propelled modular transporters (SPMT). The base section 134 can include openings configured to receive one or more SPMTs for transport. In some embodiments, each opening receives one SPMT. Each SPMT may be capable of transporting about 20 tons to about 100 tons of load. One or more SPMT can be coupled together to support additional weight depending on the module that is to be transported. The SPMT is separated from the module during installation of the module. As used herein, “SMPT” refers to a platform vehicle capable of transporting the furnace modules 100. The furnace module 100 can have a length of about 25 meters to about 90 meters, a width of about 20 meters to about 45 meters, a height of about 30 meters to about 75 meters, a weight of about 6,000 tons to about 12,000 tons, or combinations thereof. The dimensions and weight can be determined and applied based on transport parameters and operating site parameters, e.g., described in reference to FIG. 4 herein. As shown in FIG. 1, “length” refers to the x direction, “width” refers to the z direction (perpendicular to x and y directions and not shown), and “height” refers to the y direction.

Due to the large dimensions and weight of the furnace module illustrated in FIG. 1 and described above, it is particularly advantageous for operating sites subjected to low space constraints, such as a grass root olefins production plant, where few, if any, large physical obstacles exist preventing the transport and installation of the large module.

### Multiple Module Single Furnace

In some embodiments, large furnace modules each corresponding to a portion of a complete furnace can be designed, transported, and installed in an operating site that includes existing obstructions preventing, e.g., the installation of a module illustrated in FIG. 1 and described above. A single furnace can be modularized into two or more modules that can be easily installed without disassembling or breaking down the modules. FIG. 2 depicts a schematic view of a furnace assembly 200 having a convection section 210 and a radiant section 209 installed from an upper furnace module 202 and a lower furnace module 201 in accordance with one embodiment. The upper furnace module 202 can include an upper portion of a convection section 210. The upper furnace module may also include and an upper support structure 204. In some embodiments, the upper portion of the convection section included in the upper furnace module constitutes about 70% to about 100% of the vertical height of the convection section 210 of the furnace assembly. The lower furnace module 201 can include a lower portion of the convection section and the radiant section 209. The lower furnace module can also include a lower support structure 203. In some embodiments, the lower section of the convection section included in the lower furnace module 209 constitutes, e.g., from 0.1%, 0.5%, 1%, 5%, 10%, to 15%, 20%, 25%, or 30%, of the vertical height convection section 210. The upper furnace module and the lower furnace module can be fabricated separately, transported separately to the operating site, and then installed at the operating site to form the designated furnace. The upper support structure 204 can be advantageously configured to stack over the lower support structure 203 at an interface 211. The interface 211 location can be determined based on the dimensions of the modules, the weight distribution of the modules, and the center of gravity position of the modules. If necessary, upon stacking the upper furnace module on the lower furnace module, additional components, such as auxiliary components and structure reinforcement components, may be added to construct a final, complete, operable furnace.

The upper support structure 204 can include a plurality of vertical support members 214 configured to align over vertical support members 215 of the lower support structure 203. Preferably, the stacked vertical support members 214 and 215 together form structure columns that extend through a majority of, or even entire, the height of the assembled furnace 200. In some embodiments, the lower support structure 203 and the upper support structure 204 are formed from steel or any material capable of supporting the structure of the final furnace structure upon completion of installation. Once installed, portions of the support structures 203, 204 can be removed or can remain in place. Conventional support structures of furnaces are typically designed to support furnaces installed from the ground up. However, the support structures 203, 204 can be designed to ensure structural integrity of the modules when lifted from an upper portion thereof. e.g., by including the large vertical members 214, 215. Cranes, such as a gantry crane, may be utilized to lift a module from an upper location of the module.

The furnace assembly 200 can include at least one control valve deck 212 including block valves, control valves, and/or piping. In some embodiments, a steam drum 206 can be included in the upper furnace module 202.

The lower furnace module 201 can have, e.g., a length of about 15 meters to about 50 meters, a width of about 10 meters to about 30 meters, a height of about 15 meters to about 50 meters, a weight of about 60) tons to about 8,000 tons, or combinations thereof. The dimensions and weight can be determined based on transport parameters and operating site parameters.

The upper furnace module 202 can have, e.g., a length of about 15 meters to about 50 meters, a width of about 10 meters to about 30 meters, a height of about 15 meters to about 50 meters, a weight of about 800 tons to about 10,000 tons, or combinations thereof. The dimensions and weight can be determined based on transport parameters and operating site parameters. In some embodiments, the upper furnace module 202 can have a height H(ufm) and the lower furnace module 201 can have a height of H(lfm). Preferably, 0.8≤H(ufm)/H(lfm)≤1.2 more preferably 0.9<H(ufm)/H(lfm)≤1.1.

Components of the furnace (e.g., the radiant section, the convection section, a primary quench, a secondary and/or tertiary quench, a decoke drum, a control valve deck, major pipings, such as large bore pipings of about 12 inches in diameter or greater) may be arranged on either the upper furnace module 202 or the lower furnace module 201, or both (if possible, e.g., for the pipings) to optimize distribution of weight and size between the two modules. In some embodiments, a secondary transfer line exchanger (TLE) can be placed entirely in lower furnace module 201. Although not described with reference to FIG. 2, auxiliary equipment, such as an electrical room, can be installed within one or more of the modules in locations or space that are not occupied by furnace components. Including auxiliary equipment in addition to the furnace components in the modules has the following advantages: (i) reducing/minimizing required installation activities at the operating site, if the operating site parameters incentivize minimal installation activity; (ii) providing the opportunity to test the auxiliary equipment at the module fabrication site or another site prior to installation at the modules in the operating site, which may be more cost effective than testing upon completion of installation.

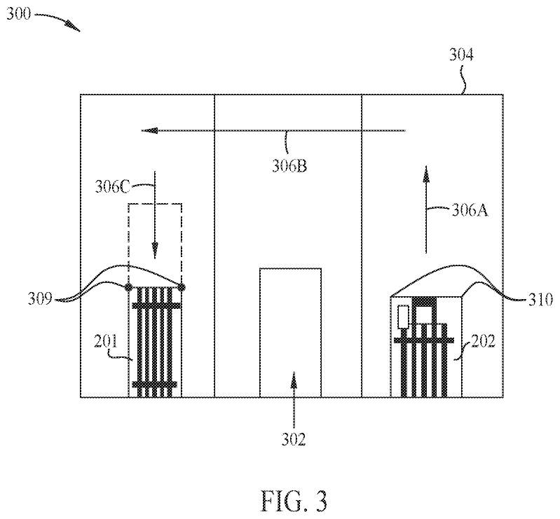

FIG. 3 depicts a module installation process at an operating site 300 in accordance with one embodiment. The operating site 300 can include existing infrastructure 304 including one or more obstructions 302, such as a pipe rack or other processing units, which can impact the ability to install large modular furnace facilities, such as the module 100 shown in FIG. 1. The maximum size of each individual module to be installed may be limited by the existing obstructions 302. The lower furnace module 201 can be installed by lifting the lower furnace module 201, such as with a crane over the obstructions 302. The lower furnace module 201 can be lifted from one or more contact points 309 on the lower support structure 203. The contact points 309 can be on an upper half portion of the module, such as on an upper 10% height of the module, or any other location on the module. The contact points 309 locations of the lower support structure 203 are capable of supporting the weight of the lower furnace module 201. The lower furnace module 201 can be lifted using a crane along path 306A, and translated along a path 306B above the obstruction 302 as a way to avoid contact of lower furnace module 201 with obstruction 302. Afterwards, the lower furnace module 201 can then be lowered to the installation location along path 306C. In some embodiments, the crane can be a temporary gantry crane, however, other structures are also contemplated, such as a crawler crane, depending on the module weight.

Similarly, the upper furnace module 202 can be lifted via contact points 310 on the upper support structure 204 along path 306A, translated along the path in direction 306B as a way to avoid contact of upper furnace module 202 with obstruction 302, and then lowered and positioned above and abutting the lower support structure 201. The contact points 310 can be on an upper half portion of the module, such as on an upper 10% of the module by height, or any other location on the upper furnace module. The contact point 310 locations of the upper support structure 204 are capable of supporting the weight of the upper furnace module 202. The support members 214 of the upper support structure 204 can be substantially aligned with the support members 215 of the lower support structure 203. In some embodiments, each support structure, includes half of the support members on a first side of the support structure, and half on the second side of the support structure. Connections between the modules can be made between one another and connections can be made from the furnace to various equipment and facilities at the operating site.

### Constructing Hydrocarbon Processing Facility

FIG. 4 depicts a flow diagram of a method for constructing a hydrocarbon processing facility in accordance with an embodiment. The method 400 includes:
selecting (402) an operating site based on location, existing infrastructure, and transport channels of the operating site;
determining (404) transport parameters, such as vessel or vehicle parameters;
determining (406) operating site parameters of the operating site;
designing (408) one or more modules based on the transport parameters and the operating site parameters;
constructing (410) the modules at a module fabrication site separate from the operating site; and
transporting (412) the modules, e.g., to the operating site.

An operating site is selected at 402 for the hydrocarbon processing facility based on location, existing infrastructure, and transport channels of the operating site. Modularization strategy can be determined by evaluating the value of modularization relative to using traditional methods of installation of hydrocarbon processing facility components, such as stick-building. Modularization strategy includes determining number of modules, dimension, weight, and components of each module. Financial benefits of modularization through economic considerations between the module fabrication site and the operating site can be calculated based on factors such as total labor cost. The total labor cost is proportional to a product of work force productivity, work force labor cost, and work hours. A work schedule is evaluated for modularization, such as by use of parallel work requirements and/or land reclamation. In some embodiments, modules can be assembled at different module fabrication site locations before being combined at the operating site. It is possible to augment or retrofit existing facilities with furnaces having modular designs of this disclosure. Large modularized furnaces of this disclosure are particularly advantageous for grass-root plants. Modules are designed, engineered and fabricated based on considerations such as transport parameters and operating site parameters.

The transport parameters at 404 can include vessel parameters, such as vessel dock length, vessel dock width, and vessel dock shape, height of obstruction(s) during transport, maximum weight capacity of vessel, economics in procuring vessels, vessel draft when loaded, depth along path during transport, or combination(s) thereof. As used herein, “vessel draft” refers to a minimum depth utilized to safely transport a vessel through a body a water, such that the bottom of the vessel hull does not contact a surface below the water. Thus, the vessel draft should be less than the depth along path during transport. In some embodiments, transportation from the module fabrication site to operating site will set the maximum physical size of each module. Although it is possible to assemble small modules, it has been discovered that maximizing the size of the modules to the extent allowable by transportation limitations provides greater benefits.

The vessel parameters can include a width allowance, a length allowance, a height allowance, and a weight allowance. A plurality of vessels can be used to transport a plurality of modules. A vessel can be configured to transport one or multiple modules, e.g., 1 to 4 modules, depending on the size and weight of the modules and the transportation vessel. Each module has a module width, a module length, a module height, and a module weight. Each module length is about 25% to about 100% of the vessel's length allowance, such as about 50% to about 90%, the module width is about 25% to about 100% of the vessel's width allowance, the module height is about 25% to about 100% of the vessel's height allowance such as about 50% to about 90%, and the module weight is about 25% to about 100% of the vessel's weight allowance such as about 50% to about 90%.

The operating site parameters at 406 can include maximum weight restrictions on roads leading to the operating site, soil conditions of roads leading to the operating site, height of obstructions along the roads leading to the operating site, width of obstructions along the roads leading to the operating site, road turn radius restrictions, live equipment lifts, workforce location at the operating site, land transport ability, or combination(s) thereof.

Designing one or more modules based on the transport parameters and operating site parameters at 408 can include designing a single module for two furnaces based on the vessel and operating site parameters, e.g., as shown in FIG. 1. Alternatively, 408 can include designing a pair of modules for a single furnace based on the vessel and operating site parameters, e.g., as shown in FIG. 2. Alternatively, 408 can include designing 3, 4, 5, 6, 7, 8, or even more modules for a single furnace or multiple identical, similar, or different furnaces based on the vessel and operating site parameters, e.g., as shown in FIG. 2. The one or more modules are sized to provide length, width, height, and/or weight of the modules within allowance of the vessel and operating site parameters. Each module is installed at the operating site independently and the modules are joined at interconnections disposed on interfaces of adjoining modules.

In some embodiments, auxiliary equipment is included in a furnace module, such as in FIG. 1. Alternatively, the auxiliary equipment is installed separately from the module, such as in FIG. 2. A center of gravity of the module can be balanced, such as building a furnace module that is “bottom heavy.” The auxiliary equipment may be tested at the module fabrication site. It has been discovered that testing the auxiliary equipment at the module fabrication site can streamline module fabrication by providing skilled persons located proximate to the module fabrication site. Thus, the resulting modules with auxiliary equipment incorporated therein can be directly installed at the operating site with reduced on-site support.

Modularization is tailorable to unique situations such as availability of skilled persons and “work hours” that can be packaged at common assembly locations.

Once the modules are built at the module fabrication site at 410, one or more modules can be transported to, loaded and positioned on the vessel. A center of gravity of one or more modules can be within a perimeter of a vessel deck of the vessel. In one example, a single ship can carry modules for 8 furnaces using 4 modules to balance the ship. In some embodiments, transporting the modules can utilize an easeway for one or more SPMTs. The vessel deck can include a foundation layout to receive and secure the module to the vessel deck, such as by welding. In some embodiments, the welding can be removed upon arriving the unloading dock, allowing the unloading of the modules from the vessel.

The modules can be transported via the vessel at 414 to an unloading port. The modules are unloaded from the vessel at an unloading dock, and then transported to the operating site using a means of ground transportation. The furnace facility is constructed at the operating site by installing the modules. The furnace facility can include, e.g., about 2 to about 20 furnaces, such as about 6 to about 14 furnaces. A larger module size can provide ease of installation of the furnace facility due to fewer modules used for installation. Multiple smaller modules results in more connections and can significantly extend the amount of time modules are installed at the operating site.

Overall, methods and systems for constructing a furnace facility of the present disclosure can efficiently take into consideration operating site parameters of an operating site and a transport vessel when designing one or more modules making up a furnace. The modules may be sized to provide maximum length, width, height, and/or weight of the modules within allowance of the transport vessel and operating site parameters. Maximizing module dimensions, weight, and weight distribution within and between modules provides efficient assembly of modules at fabrication sites separate from operating sites. Benefits include consistent labor availability, production efficiency, costs, and time savings.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

For the sake of brevity, only certain ranges are explicitly disclosed herein. However, ranges from any lower limit may be combined with any upper limit to recite a range not explicitly recited, as well as, ranges from any lower limit may be combined % with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

What is claimed is:

1. A method of constructing a furnace facility including one or more furnaces, the process comprising:
determining transport parameters;
determining operating site parameters of an operating site;
designing one or more furnace modules based on the transport parameters and the operating site parameters, the one or more furnace modules sized to provide length, width, height, and weight of the modules within allowance of the transport parameters and operating site parameters; and
constructing the one or more furnace modules at a module fabrication site separate from the operating site, the modules comprising one or more furnace components.

2. The method of claim 1, further comprising:
installing the one or more furnace modules at the operating site to construct the furnace facility.

3. The method of claim 1, wherein:
each of the one or more furnaces comprises a plurality of furnace components; and
at least one of the furnace modules comprises from 25% to 100% of the plurality of components in a designated furnace of the one or more furnaces.

4. The method of claim 3, wherein:
the designated furnace comprises a convection section and a radiant section; and
a furnace module comprises an upper module section positioned above and abutting a lower module section,
the upper module section corresponds to an upper portion of the convection section, and
the lower module section corresponds to a lower portion of the convection section and the radiant section.

5. The method of claim 4, wherein:
constructing the furnace module comprises:
constructing the upper module section and the lower module section separately;
positioning the upper module section above and abutting the lower module section; and
mechanically securing the upper module section to the lower module section to construct the furnace module.

6. The method of claim 4, wherein:
the upper module section comprises a first vertical reinforcement member;
the lower module section comprises a second vertical reinforcement member; and
the first vertical reinforcement member and the second reinforcement member are connected to form a unitary reinforcement component in the furnace module.

7. The method of claim 3, wherein:
the designated furnace comprises a convection section and a radiant section;
the one or more furnace modules include an upper furnace module and a lower furnace module;
the upper furnace module corresponds to an upper portion of the convection section; and
the lower furnace module corresponds to a lower portion of the convection section and the radiant section.

8. The method of claim 7, wherein:
the upper furnace module and the lower furnace module, separate from each, are transported to the operating site; and
at the operating site, the upper furnace module is positioned over and abutting the lower furnace module to construct the designated furnace.

9. The method of claim 7, wherein:
the transport parameter and/or the operating site parameters comprise a constraint preventing transporting an alternative module comprising the upper furnace module positioned over and abutting the lower furnace module.

10. The method of claim 1, wherein:
at least two adjacent steam cracking furnaces present in the furnace facility are connected to form a multiple-furnace cluster comprising a plurality of cluster components; and
the furnace module comprises from 60% to 100% of the plurality of cluster components in the multiple-furnace cluster.

11. The method of claim 1, wherein the furnace module comprises a plurality of structural reinforcement components that maintain structural integrity of the furnace module during fabrication, transportation, and installation thereof.

12. The method of claim 11, wherein the structural reinforcement components comprise a plurality of vertical beams and a plurality of horizontal beams.

13. The method of claim 1, wherein the furnace module further comprises auxiliary equipment.

14. The method of claim 1, wherein:
the transport parameters comprise vessel parameters;
the vessel parameters comprise a width allowance, a length allowance, a height allowance, and a weight allowance, the vessel configured to transport from one or more of the furnace modules;
each furnace module has a module width, a module length, a module height, and a module weight; and
each module length is about 25% to about 100% of the length allowance, the module width is about 25% to about 100% of the width allowance, the module height is about 25% to about 100% of the height allowance, and the module weight is about 25% to about 100% of the weight allowance.

15. The method of claim 1, wherein:
the transport parameters includes one or more of: vessel dock length, vessel dock width, and vessel dock shape, height of obstruction(s) during transport, maximum weight capacity of the vessel, economics in procuring vessels, vessel draft when loaded, depth along path during transport, and any combination thereof; and
the operating site parameters includes one or more of: maximum weight restriction of a road leading to the operating site, a soil condition of a road leading to the operating site, height of an obstruction along a road leading to the operating site, width of an obstruction along a road leading to the operating site, a road turn radius restriction, a live equipment lift, a workforce location at the operating site, a land transport ability, and a combination thereof.

16. A furnace module comprising:
at least two furnaces, each furnace comprising a radiant section and a convection section;
and
a module interconnection disposed between adjacent furnaces.

17. The furnace module of claim 16, wherein:
the module interconnection includes one or more interconnections coupling the two furnaces together.

18. The furnace module of claim 16, wherein the furnace module comprises a base section configured for transport using self-propelled modular transporters.

19. The furnace module of claim 16, further comprising:
at least one control valve deck comprising a block valve, a control valve, and one or more pipes; and
auxiliary equipment comprising an electrical room and an analyzer.

20. The furnace module of claim 16, wherein the furnace module has features selected from the group consisting of:
a length of about 25 meters to about 90 meters;
a width of about 20 meters to about 45 meters;
a height of about 30 meters to about 75 meters;
a weight of about 6,000 tons to about 12,000 tons; and
combinations thereof.

21. The furnace module of claim 16, wherein the electrical room is disposed between a control deck of each furnace and is configured to power each furnace.

22. The furnace module of claim 16, wherein the furnace module comprises a common analyzer enclosure for analyzers.

23. The furnace module of claim 16, further comprising an ammonia vaporization skid configured for selective catalytic reduction unit (SCR) on the control valve deck.

24. A furnace assembly comprising a convection section above and adjacent a radiant section, the furnace assembly comprising:
an upper furnace module corresponding to an upper portion of the convection section; and
a lower furnace module corresponding to a lower portion of the convection section and the radiant section of the furnace assembly.

25. The furnace assembly of claim 24, wherein:
the upper furnace module comprises an upper support structure;
the lower furnace module comprises a lower support structure; and
the upper support structure configured to stack over the lower support structure.
